(19) United States
(12) Patent Application Publication
(10) Pub. No.: US 2010/0065197 A1
(43) Pub. Date: Mar. 18, 2010

(54) DECORATIVE TRANSFER LABEL WITH INK-ONLY LAYER

(75) Inventors: Huibert Cornelis Kwint, Woerden (NL); Patrick Johannes Blom, Leiden (NL)

Correspondence Address: Pearne & Gordon LLP, 1801 East 9th Street, Suite 1200, Cleveland, OH, 44114-3108, US

(73) Assignee: HEINEKEN SUPPLY CHAIN B.V., AMSTERDAM (NL)

(21) Appl. No.: 12/162,208

(22) PCT Filed: Jan. 26, 2007
(86) PCT No.: PCT/NL07/50034

§ 371 Date: Oct. 10, 2008

(30) Foreign Application Priority Data
Jan. 26, 2006 (EP) 06075166.6

(51) Int. Cl. B44C 1/17; B41M 5/00; B41M 5/035; B32B 7/06

(52) U.S. Cl. 156/249; 428/41.7; 428/40.5; 428/41.6

(57) ABSTRACT

The invention relates to a transfer label comprising a backing layer and a transfer label composition, said transfer label composition comprising—at least one protective layer; —at least one ink-only image layer;—at least one adhesive layer; —at least one of said protective layers and/or at least one of said image layers comprising a mixture of at least one thermoplastic polyester ink and at least one nitrocellulose ink, the amount of polyester being less than 50 wt. % of the combined weight of the polyester ink and the nitrocellulose ink.

The invention relates to a graphic, decorative transfer label for use on articles such as plastic articles or glass articles. More in particular, the invention relates to ink-only transfer labels, i.e. labels based only on inks, which labels, when applied to a substrate, do not have a supporting film basis. These types of labels consist only of an adhesive, a number of dyed or pigmented ink-layers, and usually one or more protective layers.

Containers (such as bottles) and other articles (such as plastic crates) are often provided with a decorative label, viz. an applied layer of some sort providing a graphic image for decorative and/or informational purposes. In the art, several techniques for providing such a decorative label are known. The most common method comprises gluing paper labels to the article, particularly glass articles. However, in the past more sophisticated methods have been developed for producing decorative labels on articles reliably, in particular at a high speed.

WO-A-97/34810 describes a method wherein labels are applied on plastic crates by transferring the label ink present on a substrate to the crate's surface. This process is known in the art as an image transfer.

WO-A-97/35292 and WO-A-97/35291 also describe image transfer of what is referred to in these publications as an ink-only label. The label described in this publication is easily removable by soaking in water and consists of an adhesive layer, an ink-only image layer and optionally a protective layer.

The image transfer process is also used in WO-A-01/15915 to provide a transfer label that is opaque, and can be applied over preexisting permanent printed images on substrate surfaces.

Another approach is to print ceramic or organic ink directly on the article's surface using the screen printing technique. Although by screen printing a graphic decorative label of good quality may be obtained, this process is not suitable for high speed printing of large quantities of articles, because it requires the pressing of the ink composition through the screen, while at the same time careful positioning of the screen with respect to the article (which may have an irregular shape) is required. Furthermore, if a more complex graphic decorative label is required, e.g. composed of different colors, this requires several printing passes, each of which must be carefully synchronized with each other, which makes this technique even less suitable for providing graphic decorative labels on articles on an industrial scale. When ceramic ink is used in screen printing, this technique can only be successfully applied on glass substrates, since it requires the subsequent heating of the ink at a temperature of 400° C. or higher in order to melt the ceramic ink and obtain the decoration. Moreover, heating the articles to a temperature that is sufficient to melt the ceramic ink is not always possible. For example, if the articles to be printed are filled food containers, the heating required for melting the ceramic ink could destroy the contents.

U.S. Pat. No. 4,466,994 describes a method of transferring an ink design layer, which is screen imprinted on a release layer present on a carrier web. Upon transferring the ink layer by this known process, the release layer is also transferred to the article. Subsequently a post-flaming step is carried out in this known method during less than about two seconds in order to improve gloss characteristics.

In the development of image transfer labels and the process for applying these labels to a substrate, such as a glass substrate (bottle), various difficulties had to be overcome. In the case of labels for beverage bottles, such as beer, a difficult aspect is the economic importance to label the bottle at high speed, such as at least 200 to 400 label sets per minute, for instance comprising a back label, a body label and a neck label. Further, the label has to withstand the conditions of pasteurizing (heating at approximately 62° C. in humid conditions).

In order to produce the label under sufficiently economic conditions, the printing of the label at wide webs at high speed is an advantage (webs of at least 80 cm wide and speeds of at least 150 m/min). This places high requirements on the nature of the composition of the label (inks, adhesive, lacquers, etc.).

Further it would be very advantageous if labels could be provided having a lower cure temperature than prior art labels (especially compared to screen printing), having improved scratch resistance and/or having improved ice-water resistance.

Each of these requirements can generally quite easily be met, but usually at the expense of one or more of the other requirements.

Accordingly it is an object of the invention to provide a transfer label for image transfer and a process for applying these transfer labels to a substrate, which meets the combination of the above requirements.

It is a further object of the present invention to provide a process for applying a graphic, decorative transfer label to the surface of an article. The application of the decoration should be relatively simple, i.e., requiring a minimum number of steps, preferably only a single step. Furthermore, the process must be such that high speed operation is possible. At the same time, the decorated product obtainable by this process should have physicochemical properties which may be modified as to assure problem-free subsequent processing and/or handling of the decorated article, even under more severe conditions, such as when the decorated articles are heated and/or contacted with water. Also, the process should enable the production of decorative labels having a desirable appearance (including resolution, color space (i.e., use of the color spectrum) and texture) on all types of articles, including glass and plastic surfaces.

These and other objects of the invention have been realised by the transfer label of the invention, which is based on the surprising finding, that by using a combination of a thermoplastic polyester and a nitrocellulose as binding ink materials in the image layer and/or in the protective layer, an unexpected synergy in label properties is obtained.

Accordingly the invention provides a transfer label comprising a backing layer and a transfer label composition, said transfer label composition comprising

at least one protective layer

at least one ink-only image layer

at least one adhesive layer,

at least one of said protective layers and/or at least one of said image layers comprising a mixture of at least one thermoplastic polyester ink and at least one nitrocellulose ink, the amount of polyester being less than 50 wt. % of the combined weight of the polyester ink and the nitrocellulose ink.

The label of the invention may have the specific combination of the two ink materials either in the image layer, in the protective layer, or, which is preferred, in both the protective layer and the image layer. By these features of the invention the very good combination of processing and mechanical properties is obtained.

It is preferred that the amount of thermoplastic polyester ink is between 5 and 25 wt. % of the combined weight of the nitrocellulose ink and polyester ink, as within these ranges the optimal combination of water resistance, strength and processability is reached.

It is to be noted that the said protective layer generally contains the nitrocellulose ink and the polyester ink as the only binding ink materials, but other components may be present, such as wax or waxy materials improving the scratch resistance in the (outer) protective layer and/or dyes and pigments in the image layer.

The label of the invention further comprises an adhesive layer. This may be just one layer of, preferably an acrylate, adhesive or a combination of two or more layers, including at least one outer adhesive layer and one or more bonding layers between the outer layer and the image layer. It is also possible to include a pigmented opacifying layer underneath the image layer.

It is preferred that the adhesive in the adhesive layer has a glass transition temperature, as defined in ASTM 1356-98 (as measured by DSC) of at least 55° C., preferably at least 65° C. Glass transition temperatures of higher than 75° C. provide no additional advantage

In the transfer label, i.e. the backing layer with the transfer label material, there is also present a release layer between the upper protective layer and the backing layer. The material of this release layer may be of any suitable composition that provides the release, but preferred materials are waxy materials such as carnauba wax, montan wax, paraffinic wax, mineral wax, preferably carnauba wax, or silicone materials. It is also possible to use a siliconized carrier either alone or in combination with a separate release layer.

By the invention all functions of the decoration (including decorative/information, scratch resistance, adhesion, etc.) are obtained by choosing the ink composition, in particular by including a binder therein. For this reason this method is referred to as ink-only decoration

The decorative labels which may be obtained by the present invention are characterized by a sharp definition, viz. there is a very sharp contrast between printed areas and non-printed areas. In particular the non-printed areas directly show the surface of the articles and there are no hazy regions or rims which typically occur in decorations obtained by prior art image transfer printing techniques. Even after submersing the decorated object for some time (such as a few hours) in hot or cold water, the image features are maintained.

For the step of transferring the ink composition to the carrier sheet, by which a pattern is formed (the pattern being the negative of the final decoration), in principle any printing process or other method of application may be employed, such as screen-printing or gravure printing processes. Preferably a rotogravure printing process is used. By the rotogravure printing process high printing speeds may be obtained.

Several subsequent printing steps may be used (wherein each step may be followed by a drying step, if desired) for example to obtain a pattern and a corresponding decoration composed of different colors and/or textures. The patterns can be printed in a very high resolution, in particular when the rotogravure printing process is used and a very wide color space can be achieved.

The carrier sheet may be made from any suitable material. Examples of suitable materials are poly(ethylene-terephthalate) (PET), (oriented) polypropylene ((O)PP), polyethylene (PE), polystyrene (PS), paper or laminates thereof. Also other polymers based on these mentioned may be used. The carrier sheet may have any suitable thickness, which is typically from several tens to hundreds of μm, such as between 10 and 50 μm. More in particular, it is an advantage of the invention to use PET as the material of choice. PET has distinct advantages as backing material, especially because of its ability to be used at high speed printing and high speed high temperature application, but up to now it was virtually impossible to use PET due to problems with the application of the label thereto

Special advantages of PET are the strength thereof, the possibility to recycle the used backing layer and the good temperature resistance thereof.

One of the reasons for the impossibility to use a PET backing layer up to now, was the blocking of the PET with most inks, more in particular polyester inks. By the specific use of the combination of the inks as defined in the invention, no such blocking occurs.

The carrier sheet may, prior to the application of the ink pattern, be provided with a release promoting layer, viz. any coating that improves the transfer of the decoration from the carrier to the article.

It is preferred to print the release promoting layer in register with, viz. following the contours of, the decoration in order to prevent that after the transfer of the decoration to the article, parts of the promoting agent appear on the article's surface, which in particular in the case of glass articles may leave visible marks. Such marks may of course be removed easily by subsequent cleaning, it is however preferred not to have these marks formed to begin with. For this reason, it is preferred to use as little release promoting compound as possible. Preferably the amount of release promoting compound is less than 1 g/m², more preferred less than 0.7 g/m² (expressed as amount of compound used for the release promoting layer per unit area of carrier). Most preferably, no release promoting layer is present at all.

In case a release promoting layer is present, the release promoting action may, in case the transfer is e.g. effected by applying heat, be caused by melting, which occurs with compounds such as wax, more specifically a carnauba and/or a montan wax, or a mixture thereof. Also suitable as a release promoting compounds for use in this layer are non-melting release coatings, such as silicone. A very suitable commercially obtainable wax compound for this purpose is Michem™ Lube 156.

An interesting aspect of the invention is the printing of the release layer in registry with the image. In this way the release layer will be virtually invisible on the final label after it has been transferred to the substrate. In this respect the term ‘in registry’ indicates that the release layer is applied with a high printing tolerance, preferably of at most about 0.5 mm, more in particular at most about 0.2 mm.

The backing layer bearing the decoration may subsequently, either directly or after having been stored for some time, be transferred to the apparatus where the transfer of the decoration to the article, thus forming the final decoration, is carried out.

According to the invention, the sheet with the transfer label material is contacted with the article to be decorated, for example by employing the transfer printing process described WO-A-97/34810, WO-A-97/35292, WO-A-97/35291 and WO-A-01/15915, the contents of which publications are incorporated herein by reference. In this step the decoration is contacted with the article at a certain temperature and pressure for a certain contact time. Apart from heat activated transfer, the transfer of the decoration may for instance also be activated by applying pressure, by the application of radiation (such as UV, IR or microwave radiation, but not limited thereto) or by contact with water (water-activated).

After the decoration has been applied to the article, it may optionally be subjected to a heating step. This final heating step, which is preferably applied when providing a graphic, decorative label on a glass article, is generally carried out at a temperature of 50 to 250° C. Preferably the heating temperature is below 230° C., more preferably at a temperature of about 60 to 220° C. The duration of this final heating step is preferably more than two seconds, more preferably from about one minute to about 30 minutes.

Furthermore, decorations may be provided, the mechanical and chemical properties of which may be modified such that an improved scratch resistance can be obtained even under more severe conditions, such as under elevated temperature, which may in practice occur e.g. when the article is subjected to a pasteurization step. The compositions used in the present invention may thus essentially be free of cross-linkers, such as melamine, although this is no requirement.

The present invention is particularly useful for applying the labels to glass surface. In general, glass surfaces are more difficult to label than other surfaces, due to the inert character of glass. In addition, glass articles such as bottles, are usually subjected to severe processing conditions, which involve scuffing and/or contact with water at elevated temperature. It is surprising that according to the invention glass surfaces, particularly bottles, may be provided with a label having the desired functionality with respect to scratch resistance.

The preparation of an ink composition typically involves the following steps.

a. Preparation of a ‘vehicle’ or extender, choosing a polymeric binder (e.g. a polyester and/or a mixture of nitrocellulose) and dissolving the binder in a suitable solvent. The amount of solvent is typically 70-80 wt. %. Typical solvent is ethylacetat.

b. Addition of ink pigments (‘colorants’) to the vehicle or extender. The ratio pigment:binder is typically 2:1 to 3:1 for inorganic pigments (e.g. titanium white, TiO₂). After addition of the pigment, the composition is mixed, e.g. by grounding in a three-roll mill or a shot mill. Typically, the solid distribution is 75% pigments to 25% binder. The solvent content will usually drop to 25-35 wt. % after addition of the pigments. The ratios pigment:binder when organic pigments, such as carbon black are used, are generally the opposite of those for inorganic: ca. 1:2 to 1:3.

c. Addition of solvent to reach the proper viscosity for printing. The solvent content may thus be increased from 25-35 wt. % to 65-75 wt. %. When water is used, the solvent content is generally somewhat lower at this stage, typically 25-50 wt. %.

d. In order to improve scratch resistance a wax additive is added. Typically a microsized PE is used, 0.3-1.6 wt. % of the binder, particle size typically 3-8 μm. Monomeric plasticizers were not added to the lacquers.

Also very suitable is a precoating of at least one polyvinyl alcohol, in particular the polyvinyl alcohols described in WO-A-02/28732, which reference is incorporated herein by reference.

A part of the invention is that PVA is an ideal substitution for PE as pre coating on bottles. PVA makes good adhesion of label to glass possible (contrary to PE), the lubricating properties of PVA are comparable with PE. In case of the use of an acrylate adhesive, the combination of a PVA-coating with the transfer label of the invention has the added advantage of a superior adhesion between the coated substrate and the transferred label.

When glass surfaces are to be provided with a graphic, decorative label in accordance with the present invention, it is preferred to provide a precoat on the glass surface in order to improve the adhesion. Suitable for this purpose are e.g. aminosilane compounds, which are generally water soluble, or epoxysilane compounds (such as gamma-glycidoxypropyltrimethoxysilane, commercially obtainable e.g. as A-187 from OSI Specialties/Crompton Nev., Zwijndrecht, Belgium), which are generally soluble in alcohol. The aminosilane compounds are preferred for this purpose. Suitable aminosilane compounds are e.g. A-1100 (gamma-aminopropyltriethoxysilane, from OSI Specialties/Crompton Nev.) and Dynasylan™ HS 2776 (from Degussa-Huels AG, Hanau, Germany, which comprises 30% alkylpolysiloxanes, aminomodified in water), although this all is not required.

Very suitable commercially available polyester compounds which may be used as a binder in accordance with the present invention, in particular for decorating glass surfaces are Dinapol™ (manufactured by Creanova Inc, Somerset, N.J., US) and Vitel™ (manufactured by Bostik, Middleton, Mass., US). Particularly preferred are Dinapol™ S-1606 and Dinapol™ S-1611, or mixtures thereof.

Suitable nitrocellulose binders for use in this invention, both in the protective layer and in the image layer are an E type NC (typical Nitrogen content between 11.8-12.3%). Those NC types are not any more solvable with only ethanol. The main solvent typically is ethylacetat for these types of NC binders. Monomeric plasticizers were not added to the lacquers.

The ink composition according to the present invention may further comprise one or more plasticizers, the solvent and/or one or more pigments. Furthermore, additives such as resin forming compounds (e.g. melamine formaldehyde resin) optionally in combination with crosslinking compounds (e.g. Resamine™797, manufactured by Solutia Inc., St. Louis, Mo., US) may be present. Other additives are catalysts to start the crosslinking reaction (such as the acid catalyst sulfonic acid/amine salts, e.g. obtainable as Cycat™ 4045 and K-cure™ 1040) and/or plasticizers, such as glyceryl tribenzoate (e.g. Uniplex 260).

### EXAMPLE

On a backing layer of 36 μm polyester, initially a release lacquer of Carnauba wax is applied at 0.7 g/m² with an artwork overshoot of +0.5 mm. Then first a protective layer is applied consisting of nitrocellulose and polyester in a weight ratio of 95/5 in an amount of 1 g/m². Subsequently a second protective layer is applied with the same composition and the same amount as the first protective layer. On top of this protective layer four ink-only image layers were applied, blue, black, red and white. The ink consisted of nitrocellulose for the blue, black and red. The white ink consisting of nitrocellulose and polyester in a ratio of 90/10. The amount of the two white image layers combined was 10 g/m2. As last layer an adhesive layer was applied in an amount of 1 g/m². This layer consisted of polyacrylate.

The complete label was used in an image transfer process with an application speed of 200 bpm, a pre-heated bottle temperature of 135° C., a web heater of 100° C., a turret (body application) temperature of 160° C. and a neck application temperature of 170° C. The label as applied on the bottle has been cured in a cure oven at a profile of six zones: 190-200-210-210-220-180 for 24 minutes in total in which the residence time for each subsequent temperature has been 8 minutes per zone. The final label properties were:

1. fully resistant against any sort damage to water of 65° C. for 120 minutes
2. a dry scratch resistance of 7N 72 hour after application
3. alcohol rub resistance
4. AGR bottle test machine resistance for 18 minutes.

1. Transfer label comprising a backing layer and a transfer label composition, said transfer label composition comprising at least one protective layer at least one ink-only image layer—at least one adhesive layer at least one of said protective layers and/or at least one of said image layers comprising a mixture of at least one thermoplastic polyester ink and at least one nitrocellulose ink, the amount of polyester being less than 50 wt. % of the combined weight of the polyester ink and the nitrocellulose ink. 2. Transfer label according to claim 1, wherein the said protective layer comprises at least one thermoplastic polyester ink and at least one nitrocellulose ink, the amount of polyester ink being less than 50 wt. %, preferably less than 10 wt. % of the combined weight of the polyester ink and the nitrocellulose ink. 3. Transfer label according to claim 1 or 2, wherein the said image layer comprises at least one thermoplastic polyester ink and at least one nitrocellulose ink, the amount of polyester ink being less than 50 wt. %, preferably less than 10 wt. % of the combined weight of the polyester ink and the nitrocellulose ink. 4. Transfer label according to claim 1-3, wherein the said adhesive layer comprises an acrylate adhesive, preferably having a Tg of at least 45° C., more preferred at least 55° C.

2. Transfer label according to claim 1, wherein the said protective layer comprises at least one thermoplastic polyester ink and at least one nitrocellulose ink, the amount of polyester ink being less than 50 wt. %, preferably less than 10 wt. % of the combined weight of the polyester ink and the nitrocellulose ink.

3. Transfer label according to claim 1, wherein the said image layer comprises at least one thermoplastic polyester ink and at least one nitrocellulose ink, the amount of polyester ink being less than 50 wt. %, preferably less than 10 wt. % of the combined weight of the polyester ink and the nitrocellulose ink.

4. Transfer label according to claim 1, wherein the said adhesive layer comprises an acrylate adhesive, preferably having a Tg of at least 45° C., more preferred at least 55° C.

5. Transfer label according to claim 1, wherein the said protective layer comprises two layers, each preferably in an amount of between 0.5 and 5 g/m².

6. Transfer label according to claim 1, wherein the transfer label further comprises a release layer, positioned between the protective layer and the backing layer, said release layer preferably being a waxy release layer.

7. Transfer label according to claim 6, wherein the wax of the release layer is selected from the group of carnauba wax, montan wax, paraffinic wax, mineral wax, preferably carnauba wax.

8. Transfer label according to claim 1, wherein the backing layer is based on a polyester, preferably polyethylene therephtalate.

9. Transfer label according to claim 1, wherein the adhesive layer is present in an amount of at least 0.5 g/m².

10. Transfer label according to claim 1, wherein the said image layer comprises two opaque pigmented layers, and at least one additional pigmented or dyed image layer.

11. Transfer label according to claim 6, wherein the release layer is present in register with the label image.

12. Process for applying a label to a substrate material, preferably glass, that is preferably coated with polyvinyl alcohol, said process comprising applying a transfer label composition comprising at least one protective layer—at least one ink-only image layer at least one adhesive layer at least one of said protective layers and/or at least one of said image layers comprising at least one thermoplastic polyester ink and at least one nitrocellulose ink, the amount of polyester ink being less than 50 wt. % of the combined weight of the polyester ink and the nitrocellulose ink, to said substrate material, using the transfer label of claim 1.

13. Process according to claim 12, wherein the transferred transfer label composition is subjected to a high temperature curing after application to the substrate material.

14. Process according to claim 13, wherein the said curing includes subjecting the label material to a temperature of at least 160 C, preferably for at most 1800 seconds.
